(19) United States
(12) Patent Application Publication
(10) Pub. No.: US 2025/0116055 A1
(43) Pub. Date: Apr. 10, 2025

(54) WASHING MACHINE

(71) Applicant: SAMSUNG ELECTRONICS CO., LTD., Suwon-si (KR)

(72) Inventors: Jeongyun LEE, Suwon-si (KR); Changnyeun KIM, Suwon-si (KR); Yeajin CHO, Suwon-si (KR); Hwangmook CHO, Suwon-si (KR)

(73) Assignee: SAMSUNG ELECTRONICS CO., LTD., Suwon-si (KR)

(21) Appl. No.: 18/918,472

(22) Filed: Oct. 17, 2024

Related U.S. Application Data
(63) Continuation of application No. PCT/KR2024/014174, filed on Sep. 20, 2024.

(30) Foreign Application Priority Data
Oct. 5, 2023 (KR) 10-2023-0132887
Dec. 7, 2023 (KR) 10-2023-0176976

(51) Int. Cl. D06F 43/08

(52) U.S. Cl. CPC D06F 43/08

(57) ABSTRACT

A washing machine may include a washing tub configured to wash laundry with carbon dioxide; a compressor configured to compress the carbon dioxide discharged from the washing tub; a first storage tank connected to the compressor and configured to store carbon dioxide; a second storage tank connected to the compressor and configured to store carbon dioxide; a distillation tank to accommodate carbon dioxide and foreign matter discharged from the washing tub and to evaporate the carbon dioxide so that the foreign matter and the carbon dioxide evaporated in the distillation tank are separated; and a first pressure relief valve on a first discharge flow path between the washing tub and the second storage tank, and configured to open in response to pressure in the washing tub being greater than or equal to a first pressure so that carbon dioxide in the washing tub is moved to the second storage tank.

### CROSS-REFERENCE TO RELATED APPLICATIONS

This is a continuation application, under 35 U.S.C. § 111 (a), of International Application PCT/KR2024/014174, filed Sep. 20, 2024, which claims priority under 35 U.S.C. § 119 to Korean Patent Application No. 10-2023-0132887, filed Oct. 5, 2023 and Korean Patent Application No. 10-2023-0176976, filed Dec. 7, 2023, in the Korean Intellectual Property Office, the disclosures of which are incorporated herein in their entireties by reference.

### TECHNICAL FIELD

The disclosure relates to a washing machine.

### BACKGROUND ART

In general, washing machines are devices that use water as a solvent to wash laundry. In contrast, dry cleaning washing machines use a volatile organic compound instead of water as a laundry solvent to wash laundry without water. The dry cleaning washing machines may use solvent-based, petroleum-based laundry solvents, and the like.

Washing machines that use water may generate wastewater during the washing process and pollute the environment, while solvent-based and petroleum-based laundry solvents used in dry cleaning washing machines may be harmful to the human body and pollute the environment.

Carbon dioxide may be used as a laundry solvent to replace the laundry solvent described above. Carbon dioxide has a lower viscosity than water, so it may easily penetrate between fibers and remove contaminants. After the washing process, the carbon dioxide containing foreign substances may be evaporated to separate the carbon dioxide and the foreign substances, and the evaporated carbon dioxide may be reused.

Carbon dioxide is one of the common components of the atmosphere, and thus it does not pollute the environment. In addition, liquid carbon dioxide may be evaporated and liquefied for reuse, so it does not produce much carbon dioxide, which may also contribute to achieving carbon neutrality.

### DISCLOSURE

### Technical Problem

One aspect of the present disclosure provides a washing machine that includes two carbon dioxide storage tanks having different internal pressures, thereby enabling the interior of a washing tub to be depressurized using only one compressor after a washing process.

Further, one aspect of the present disclosure provides a washing machine capable of preventing overloading of a compressor by dividing and recovering carbon dioxide in a washing tub into a first storage tank and a second storage tank.

Further, one aspect of the present disclosure provides a washing machine capable of maintaining a stable internal pressure in a washing tub, a first storage tank, and a distillation tank by including pressure relief valves connected with each of the washing tub, the first storage tank, and the distillation tank.

Further, one aspect of the present disclosure provides a washing machine capable of reusing carbon dioxide by allowing carbon dioxide discharged through at least one of the pressure relief valves connected with each of a washing tub, a first storage tank, and a distillation tank to be moved to a second storage tank when the at least one of the pressure relief valves is opened.

Further, one aspect of the present disclosure provides a washing machine capable of maintaining a stable internal pressure in a second storage tank and reusing carbon dioxide by moving carbon dioxide in the second storage tank to a compressor when the internal pressure in the second storage tank increase greater than or equal to a set value.

Technical tasks to be achieved in this document are not limited to the technical tasks mentioned above, and other technical tasks not mentioned will be clearly understood by those skilled in the art from the description below.

### Technical Solution

According to an embodiment of the disclosure, a washing machine may include a washing tub configured to wash laundry with carbon dioxide, a compressor configured to compress the carbon dioxide discharged from the washing tub, a first storage tank connected to the compressor and configured to store carbon dioxide, a second storage tank connected to the compressor and configured to store carbon dioxide, a distillation tank configured to accommodate carbon dioxide and foreign matter discharged from the washing tub and to evaporate the carbon dioxide accommodated in the distillation tank so that the foreign matter and the carbon dioxide evaporated in the distillation tank are separated; and a first pressure relief valve on a first discharge flow path between the washing tub and the second storage tank, and configured to open in response to a pressure in the washing tub being greater than or equal to a first pressure so that carbon dioxide in the washing tub is moved from the washing tub to the second storage tank.

The washing machine may further include: a second pressure relief valve on a second discharge flow path between the first storage tank and the second storage tank, and configured to open in response to a pressure in the first storage tank being greater than or equal to a second pressure so that at least a portion of the carbon dioxide stored in the first storage tank is moved from the first storage tank to the second storage tank.

The washing machine may further include: a third pressure relief valve on a third discharge flow path between the distillation tank and the second storage tank, and configured to open in response to a pressure in the distillation tank being greater than or equal to a third pressure so that at least a portion of the carbon dioxide accommodated in the distillation tank is moved from the distillation tank to the second storage tank.

The first storage tank may be configured to store carbon dioxide at a first pressure level, and the second storage tank may be configured to store carbon dioxide at a second pressure level which is lower than the first pressure level.

The first pressure, the second pressure, and the third pressure may be greater than the second pressure level.

The washing machine may further include: a connecting flow path configured to connect the first discharge flow path, the second discharge flow path, and the third discharge flow path to the second storage tank to guide movement of carbon dioxide from at least one of the washing tub, the first storage tank, and the distillation tank to the second storage tank.

The washing machine may further include: a fourth pressure relief valve on a fourth discharge flow path between the second storage tank and an inlet side of the compressor, and configured to open and close so that, when the fourth pressure relief valve is opened, the fourth discharge flow path is opened and carbon dioxide stored in the second storage tank is moved from the second storage tank to the inlet side of the compressor.

The washing machine may further include: a controller configured to control the fourth pressure relief valve to open and close.

The first pressure relief valve may include a first elastic member and the first pressure may be determined by an elastic force of the first elastic member, the second pressure relief valve may include a second elastic member and the second pressure may be determined by an elastic force of the second elastic member, and the third pressure relief valve may include a third elastic member and the third pressure may be determined by an elastic force of the third elastic member.

The washing machine may further include: a first valve configured to open and close a first flow path between the second storage tank and the washing tub so that, when the first valve is opened, carbon dioxide stored in the second storage tank is moved from the second storage tank to the washing tub, and a second valve configured to open and close a second flow path between the first storage tank and the washing tub so that, when the second valve is opened, carbon dioxide stored in the first storage tank is moved from the first storage tank to the washing tub.

The washing machine may further include: a controller configured to control the compressor, the first valve, and the second valve, wherein the controller is configured to: when carbon dioxide is supplied to the washing tub, open the first valve so that the carbon dioxide stored in the second storage tank is moved to the washing tub, and based on the pressure in the washing tub, close the first valve and open the second valve so that the carbon dioxide stored in the first storage tank is moved to the washing tub.

The controller may be further configured to: after opening the first valve, close the first valve and open the second valve in response to the pressure in the washing tub being balanced with the pressure in the second storage tank.

The controller may be further configured to: after opening the first valve, close the first valve and open the second valve in response to the pressure in the washing tub being greater than or equal to a threshold pressure.

According to an embodiment of the disclosure, a washing machine includes a washing tub configured to wash laundry using carbon dioxide, a compressor configured to compress the carbon dioxide discharged from the washing tub, a first storage tank connected to the compressor and configured to store carbon dioxide, a second storage tank separable from the first storage tank and configured to store carbon dioxide, a distillation tank configured to accommodate the carbon dioxide and foreign matter discharged from the washing tub and to evaporate the carbon dioxide therein, a washing tub recovery flow path connecting the washing tub, the compressor, and the second storage tank to allow the carbon dioxide discharged from the washing tub to be moved to the second storage tank through the compressor, a first discharge flow path connecting the washing tub and the second storage tank to allow the carbon dioxide discharged from the washing tub to be moved to the second storage tank, and a first pressure relief valve disposed on the first discharge flow path and configured to open in response to the pressure in the washing tub being greater than or equal to a predetermined first pressure.

### DESCRIPTION OF DRAWINGS

FIG. 1 is a conceptual diagram illustrating a flow of carbon dioxide in a washing machine according to an embodiment.

FIG. 2 is a control block diagram of the washing machine according to an embodiment.

FIG. 3 is a conceptual diagram illustrating a flow path of gaseous carbon dioxide moving from a second storage tank to a washing tub in the washing machine according to an embodiment.

FIG. 4 is a conceptual diagram illustrating a flow path of gaseous carbon dioxide moving from a first storage tank to the washing tub in the washing machine according to an embodiment.

FIG. 5 is a conceptual diagram illustrating the flow of carbon dioxide moving from a supplementary tank to the washing tub in the washing machine according to an embodiment.

FIG. 6 is a conceptual diagram illustrating a flow path of liquid carbon dioxide moving from the first storage tank to the washing tub in the washing machine according to an embodiment.

FIG. 7 is a conceptual diagram illustrating a flow path of gaseous carbon dioxide moving from the washing tub to the distillation tank and a flow path of liquid carbon dioxide moving from the washing tub to the distillation tank in the washing machine according to an embodiment.

FIG. 8 is a conceptual diagram illustrating a process for recovering carbon dioxide in the distillation tank to the first storage tank, in the washing machine according to an embodiment.

FIG. 9 is a conceptual diagram illustrating a process for recovering carbon dioxide in the washing tub to the first storage tank, in the washing machine according to an embodiment.

FIG. 10 is a conceptual diagram illustrating a process for recovering carbon dioxide from the washing tub to the second storage tank in the washing machine according to an embodiment.

### MODES OF THE INVENTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

Herein, the expressions “a first”, “a second”, “primary”, “secondary”, etc., may simply be used to distinguish an element from other elements, but is not limited to another aspect (e.g., importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

The terms “including”, “having”, and the like are used to specify features, numbers, steps, operations, elements, components, or combinations thereof, but do not preclude the presence or addition of one or more of the features, figures, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

A washing machine according to various embodiments may include a housing accommodating a number of components therein. The housing may be arranged in the form of a box with an inlet for laundry on one side thereof.

The washing machine may include a door to open or close the laundry inlet. The door may be rotatably mounted to the housing by a hinge. At least a portion of the door may be configured to be transparent or translucent to allow the interior of the housing to be visible.

The washing machine may include a drum provided to accommodate laundry.

The drum may rotate within the housing to perform each of a washing, rinsing, and spin-drying processes. A plurality of through holes may be formed in a cylindrical wall of the drum.

The washing machine may include a drive device configured to rotate the drum. The drive device may include a drive motor and a rotating shaft for transmitting a drive force generated by the drive motor to the drum.

The drive device may be configured to rotate the drum in a forward or reverse direction to perform the respective operations according to the washing and rinsing processes.

The washing machine may include a control panel disposed on one side of the housing. The control panel may provide a user interface for interaction between a user and the washing machine. The user interface may include at least one input interface and at least one output interface.

The at least one input interface may convert sensory information received from a user into an electrical signal.

The at least one input interface may include a power button, an operation button, a course selection dial (or a course selection button), and a washing/rinsing/spin-drying setting button. The at least one input interface may include a tact switch, a push switch, a slide switch, a toggle switch, a micro switch, a touch switch, a touch pad, a touch screen, a jog dial, and/or a microphone.

The at least one output interface may visually or audibly transmit information related to the operation of the washing machine to a user.

For example, the at least one output interface may transmit information related to a washing course, operation time of the washing machine, and washing/rinsing/spin-drying settings to the user. Information about the operation of the washing machine may be output through a screen, an indicator, or voice. The at least one output interface may include a Liquid Crystal Display (LCD) panel, a Light Emitting Diode (LED) panel, or a speaker.

The washing machine may include a communication module for wired and/or wireless communication with an external device.

The communication module may include at least one of a short-range wireless communication module and a long-range wireless communication module.

The communication module may transmit data to an external device (e.g., a server, a user device, and/or a home appliance) or receive data from the external device. For example, the communication module may establish communication with a server and/or a user device and/or a home appliance, and transmit and receive various types of data.

For the communication, the communication module may establish a direct (e.g., wired) communication channel or a wireless communication channel between external devices, and support the performance of the communication through the established communication channel. According to one embodiment, the communication module may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or WAN). These various types of communication modules may be integrated as one component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server on a mobile communication network.

According to one embodiment, the communication module may communicate with an external device such as a server, a user device and other home appliances through an access point (AP). The access point (AP) may connect a local area network (LAN), to which a washing machine or a user device is connected, to a wide area network (WAN) to which a server is connected. The washing machine or the user device may be connected to the server through the wide area network (WAN). The controller may control various components of the washing machine (e.g., the drive motor, and the water supply valve). The controller may control various components of the washing machine to perform at least one operation including water supply, washing, rinsing, and/or spin-drying according to a user input. For example, the controller may control the drive motor to regulate the rotational speed of the drum.

The controller may include hardware such as a CPU or memory, and software such as a control program. For example, the controller may include at least one memory for storing an algorithm and program-type data for controlling the operation of components in the washing machine, and at least one processor configured to perform the above-mentioned operation by using the data stored in the at least one memory. The memory and the processor may each be implemented as separate chips. The processor may include one or more processor chips or may include one or more processing cores. The memory may include one or more memory chips or one or more memory blocks. Alternatively, the memory and the processor may be implemented as a single chip.

Hereinafter, various embodiments according to the disclosure will be described in detail with reference to the accompanying drawings.

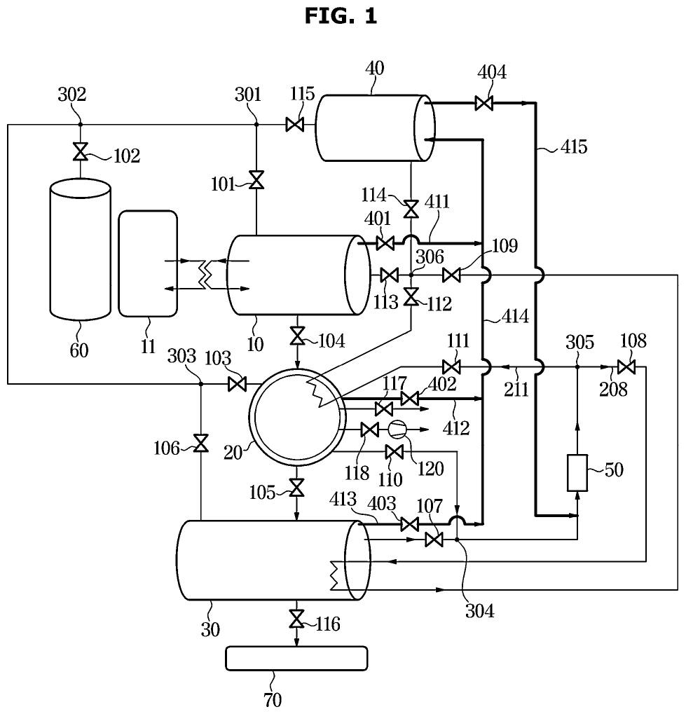

FIG. 1 is a conceptual diagram for explaining a flow of carbon dioxide in a washing machine according to an embodiment.

Referring to FIG. 1, a washing machine according to an embodiment may include a first storage tank 10 and a second storage tank 40 provided to store carbon dioxide, a washing tub 20 provided to perform washing therein using carbon dioxide, a distillation tank 30 provided to accommodate carbon dioxide and foreign matter discharged from the washing tub 20, a foreign matter tank 70 provided to store and discharge foreign matter discharged from the distillation tank 30, a compressor provided to compress carbon dioxide, and a chiller 11 provided to cool the first storage tank 10. The washing machine may further include a supplementary tank 60 provided to replenish carbon dioxide lost during the process of returning carbon dioxide after washing.

The first storage tank 10 may be configured to store carbon dioxide. The first storage tank 10 may be configured to store gaseous carbon dioxide and liquid carbon dioxide. The first storage tank 10 may maintain an internal pressure above a predetermined pressure so as to store liquid carbon dioxide. The first storage tank 10 may store carbon dioxide at a first pressure level. For example, the first pressure level may be approximately 30 to 70 bar. In other words, the internal pressure of the first storage tank 10 may be approximately 30 to 70 bar.

The first storage tank 10 may include a first outlet primarily arranged to discharge gaseous carbon dioxide and a second outlet primarily arranged to discharge liquid carbon dioxide. The first storage tank 10 may include an inlet through which carbon dioxide is introduced from the outside. The first outlet may be formed at a higher position than the second outlet so that the liquid carbon dioxide in the first storage tank 10 is not discharged through the first outlet, but mainly gaseous carbon dioxide is discharged. The inlet may be formed at a higher position than the second outlet so that the liquid carbon dioxide in the first storage tank 10 is not discharged through the inlet. For example, the first outlet and the inlet may be formed at a position higher than the high water level of the liquid carbon dioxide stored in the first storage tank 10. However, liquid carbon dioxide and gaseous carbon dioxide may coexist within the first storage tank 10, and depending on temperature and pressure conditions, liquid carbon dioxide may be evaporated into gaseous carbon dioxide, or gaseous carbon dioxide may be liquefied into liquid carbon dioxide. Accordingly, gaseous carbon dioxide and liquid carbon dioxide may be discharged together through the first outlet, liquid carbon dioxide and gaseous carbon dioxide may be discharged together through the second outlet, and gaseous carbon dioxide and liquid carbon dioxide may be introduced together or liquid carbon dioxide may be introduced through the inlet.

The chiller 11 may be configured to cool the first storage tank 10. The chiller 11 may liquefy the gaseous carbon dioxide within the first storage tank 10 by cooling the first storage tank 10. Accordingly, the gaseous carbon dioxide recovered from the washing tub 20 and the distillation tank 30 may be liquefied. The liquefied carbon dioxide may be discharged from the first storage tank 10 back to the washing tub 20 to be used for washing. The chiller 11 may liquefy the carbon dioxide recovered in a gaseous state, thereby allowing the carbon dioxide to circulate through the first storage tank 10, the washing tub 20, and the distillation tank 30. The chiller 11 may include an evaporator of a heat pump. Alternatively, the chiller 11 may include at least one of a variety of types of cooling devices.

According to an embodiment, the chiller 11 may liquefy gaseous carbon dioxide recovered from the distillation tank 30 or the washing tub 20 to the first storage tank 10 before it is introduced into the first storage tank 10. As a result, gaseous carbon dioxide may not be introduced into the first storage tank 10, and liquid carbon dioxide may be introduced into the first storage tank 10. The introduction of liquid carbon dioxide into the first storage tank 10 may be more advantageous in terms of stability than the introduction of gaseous carbon dioxide. Alternatively, a cooling device other than the chiller 11 may liquefy the gaseous carbon dioxide returned to the first storage tank 10 from the distillation tank 30 or the washing tub 20. The cooling device may include an evaporator of a heat pump.

The washing tub 20 may provide a space for washing laundry using liquid carbon dioxide as a laundry solvent. The washing tub 20 may store liquid carbon dioxide and gaseous carbon dioxide therein. The washing tub 20 may have the internal pressure maintained above a predetermined pressure to allow liquid carbon dioxide to be stored therein. The internal pressure of the washing tub 20 may be maintained at approximately 30 to 60 bar. A drum (not shown) may be rotatably disposed within the washing tub 20.

The washing tub 20 may be disposed at a lower position than the first storage tank 10. Accordingly, the carbon dioxide stored in the first storage tank 10 may be moved from the first storage tank 10 to the washing tub 20 by gravity without power. Liquid carbon dioxide may be moved primarily by gravity to the washing tub 20 through the second outlet of the first storage tank 10.

During the process of loading laundry into the drum inside the washing tub 20, air may be introduced into the washing tub 20. When air is introduced into the washing tub 20, moisture contained in the air may condense during the process of reducing the pressure in the washing tub 20 after washing is completed. Condensation of moisture introduced into the laundry may cause damage to the laundry. To prevent such a situation, the washing machine may include a vacuum pump 120 provided to evacuate the air inside the washing tub 20.

The distillation tank 30 may be configured to accommodate carbon dioxide and foreign matter discharged from the washing tub 20 after washing. In particular, the distillation tank 30 may accommodate therein liquid carbon dioxide, foreign matter dissolved or undissolved in the liquid carbon dioxide, and gaseous carbon dioxide discharged from the washing tub 20.

The washing machine may recover the carbon dioxide in the distillation tank 30 to the first storage tank 10. The gaseous carbon dioxide in the distillation tank 30 may be moved to an inlet end of a compressor 50 by a pressure difference, and the carbon dioxide introduced into the inlet end of the compressor 50 may be compressed by the compressor 50 and then moved to the first storage tank 10. The liquid carbon dioxide in the distillation tank 30 may be evaporated by heat applied to the distillation tank 30. As described above, the evaporated gaseous carbon dioxide may move to the inlet end of the compressor 50, and may move to the first storage tank 10 after being compressed by the compressor 50. As the liquid carbon dioxide evaporates, foreign matter dissolved in the liquid carbon dioxide may be separated from the liquid carbon dioxide. The foreign matter in the distillation tank 30 may be discharged to the foreign matter tank 70 after the carbon dioxide in the distillation tank 30 is returned to the first storage tank 10.

In the above process, the gaseous carbon dioxide discharged from the distillation tank 30 may become gaseous carbon dioxide at a high temperature and a high pressure while passing through the compressor 50. The gaseous carbon dioxide whose temperature is increased by passing through the compressor 50 may exchange heat with the distillation tank 30, thereby supplying heat to the interior of the distillation tank 30. In the process of returning the carbon dioxide in the distillation tank 30 to the first storage tank 10, the temperature of the carbon dioxide passing through the compressor 50 may be increased and the heat of the carbon dioxide may be supplied to the distillation tank 30, thereby evaporating the liquid carbon dioxide in the distillation tank 30. According to an embodiment, the high temperature carbon dioxide passing through the compressor 50 may pass through the distillation tank 30 and exchange heat with the carbon dioxide in the distillation tank 30, thereby providing heat to the distillation tank 30 without including a heat source, such as a separate heater. To supply more heat to the distillation tank 30, a heating device, such as a heater, may be further included.

According to an embodiment, the gaseous carbon dioxide recovered from the distillation tank 30 to the first storage tank 10 may be liquefied by heat exchange with the chiller 11 or a separate heat exchanger before being introduced into the first storage tank 10 and then be introduced into the first storage tank 10 as liquid carbon dioxide. In other words, the carbon dioxide recovered from the distillation tank 30 to the first storage tank 10 may be introduced into the first storage tank 10 in a liquid state. To this end, as described above, the gaseous carbon dioxide may be liquefied by heat exchanging with the chiller 11 or a separate heat exchanger before entering the first storage tank 10. It may be advantageous in terms of stability to liquefy the gaseous carbon dioxide and then introduce the liquid carbon dioxide into the first storage tank 10, rather than introducing the gaseous carbon dioxide directly into the first storage tank 10.

The foreign matter tank 70 may be configured to store foreign matter discharged from the distillation tank 30. A user may discharge the foreign matter stored in the foreign matter tank 70 at an appropriate intervals. The frequency of emptying the foreign matter tank 70 may vary depending on the capacity of the foreign matter tank 70 and the amount of foreign matter contained in the laundry.

The second storage tank 40 may be configured to store carbon dioxide. The second storage tank 40 may be arranged to store carbon dioxide therein. The second storage tank 40 may primarily store gaseous carbon dioxide therein. The second storage tank 40 may store carbon dioxide at a second pressure level. The second pressure level may be approximately 10 to 70 bar. In other words, the internal pressure of the second storage tank 40 may be approximately 10 to 70 bar.

According to an embodiment, the second storage tank 40 may store carbon dioxide at a lower pressure level than the first storage tank 10. The first storage tank 10 may store carbon dioxide at approximately 30 to 70 bar, and the second storage tank 40 may store carbon dioxide at approximately 10 to 70 bar, and thus the carbon dioxide storage pressure of the second storage tank 40 may be lower than the carbon dioxide storage pressure of the first storage tank 10. As will be described later, in the process of pressurizing the washing tub 20, when carbon dioxide from the second storage tank 40 is supplied first and carbon dioxide from the first storage tank 10 is supplied later, it is preferable that the internal pressure of the second storage tank 40 be lower than the internal pressure of the first storage tank 10. However, the present disclosure is not limited thereto, and the internal pressure of the second storage tank 40 may be equal to or greater than the internal pressure of the first storage tank 10.

The supplementary tank 60 may be configured to replenish carbon dioxide lost during the process of returning carbon dioxide after washing. The supplementary tank 60 may be arranged to store carbon dioxide therein. The supplementary tank 60 may supply carbon dioxide to the washing tub 20. The supplementary tank 60 may be arranged to be separable from the washing machine. The supplementary tank 60 may be replaceable with another supplementary tank. Alternatively, the supplementary tank 60 may be separated from the washing machine, replenished with carbon dioxide, and then be reconnected to the washing machine. The pressure in the supplementary tank 60 may be equal to or greater than the internal pressure of the first storage tank 10. The pressure in the supplementary tank 60 may be equal to or greater than the internal pressure of the second storage tank 40. The pressure in the supplementary tank 60 may be set greater than the internal pressure of the washing tub 20.

With reference to FIG. 1, the washing machine may include a first discharge flow path 412 connecting the washing tub 20 and the second storage tank 40 in order to allow the carbon dioxide discharged from the washing tub 20 to be moved to the second storage tank 40, and a second discharge flow path 411 connecting the first storage tank 10 and the second storage tank 40 in order to allow the carbon dioxide discharged from the first storage tank 10 to be moved to the second storage tank 40, and a third discharge flow path 413 connecting the distillation tank 30 and the second storage tank 40 in order to allow the carbon dioxide discharged from the distillation tank 30 to be moved to the second storage tank 40.

The washing machine may include a first pressure relief valve 402 provided on the first discharge flow path 412, a second pressure relief valve 401 provided on the second discharge flow path 411, and a third pressure relief valve 403 provided on the a third discharge flow path 413.

The first pressure relief valve 402 may be configured to open in response to the pressure in the washing tub 20 being greater than or equal to a predetermined first pressure. Although not specifically shown in the drawings, the first pressure relief valve 402 may include a first elastic member. The predetermined first pressure at which the first pressure relief valve 402 opens may be determined by an elastic force of the first elastic member. The first pressure relief valve 402 may be opened when the pressure in the washing tub 20 is greater than or equal to the predetermined first pressure, and may be closed when the pressure in the washing tub 20 is less than the predetermined first pressure. The first pressure relief valve 402 may open or close by itself depending on the pressure in the washing tub 20 without control by a controller 80, which will be described later.

The second pressure relief valve 401 and the third pressure relief valve 403 may be configured as the same or similar to the first pressure relief valve 402. However, an elastic force of a second elastic member included in the second pressure relief valve 401 and an elastic force of a third elastic member included in the third pressure relief valve 403 may not be the same. The elastic forces of the first elastic member, the second elastic member, and the third elastic member may be determined according to the design specifications of the washing machine, respectively. The elastic forces of the first elastic member, the second elastic member, and the third elastic member may all be configured the same, all may be configured different, or only two of the three may be configured the same.

The second pressure relief valve 401 may be opened when the pressure in the first storage tank 10 is greater than or equal to a predetermined second pressure, and may be closed when the pressure in the first storage tank 10 is less than the predetermined second pressure. The second pressure relief valve 401, similar to the first pressure relief valve 402, may be opened or closed by itself depending on the pressure in the first storage tank 10 without control from the controller 80.

The third pressure relief valve 403 may be opened when the pressure in the distillation tank 30 is greater than or equal to a predetermined third pressure, and may be closed when the pressure in the distillation tank 30 is less than the predetermined third pressure. The third pressure relief valve 403, similar to the first pressure relief valve 402 and the second pressure relief valve 401, may be opened or closed by itself depending on the pressure in the distillation tank 30 without control from the controller 80.

The washing machine may further include a connecting flow path 414 in connection with the first discharge flow path 402, the second discharge flow path 401, the third discharge flow path 403, and the second storage tank 40. The connecting flow path 414 may be connected to the first discharge flow path 402, the second discharge flow path 401, and the third discharge flow path 403 to guide the carbon dioxide discharged from at least one of the first discharge flow path 402, the second discharge flow path 401, and the third discharge flow path 403 to the second storage tank 40.

The predetermined first pressure at which the first pressure relief valve 402 opens may be greater than a pressure level inside a conventional washing tub 20. This is because the first pressure relief valve 402 is required to be opened to prevent an accident, such as an explosion of the washing tub 20, due to excessive pressure in the washing tub 20.

The predetermined second pressure at which the second pressure relief valve 401 opens may be greater than the pressure level inside the conventional first storage tank 10. In other words, the predetermined second pressure may be greater than the first pressure level. This is because the second pressure relief valve 401 is required to be opened to prevent an accident, such as an explosion of the first storage tank 10, due to excessive pressure in the first storage tank 10.

The predetermined third pressure at which the third pressure relief valve 403 opens may be greater than the pressure level inside the conventional distillation tank 30. This is because the third pressure relief valve 403 is required to open to prevent accidents, such as explosion of the distillation tank 30, due to excessively high pressure in the distillation tank 30.

The predetermined first pressure at which the first pressure relief valve 402 opens may be greater than the second pressure level at which the second storage tank 40 stores carbon dioxide. When the first pressure relief valve 402 opens, a pressure difference between the predetermined first pressure and the second pressure level may cause the gaseous carbon dioxide in the washing tub 20 to be moved to the second storage tank 40 without a separate power source. When the first pressure relief valve 402 is opened, the carbon dioxide discharged from the washing tub 20 to the first discharge flow path 412 may move along the connecting flow path 414 to the second storage tank 40.

The predetermined second pressure at which the second pressure relief valve 401 opens may be greater than the second pressure level at which the second storage tank 40 stores carbon dioxide. When the second pressure relief valve 401 opens, a pressure difference between the predetermined second pressure and the second pressure level may cause the gaseous carbon dioxide in the first storage tank 10 to move to the second storage tank 40 without a separate power source. When the second pressure relief valve 401 is opened, the carbon dioxide discharged from the first storage tank 10 to the second discharge flow path 411 may move along the connecting flow path 414 to the second storage tank 40.

The predetermined third pressure at which the third pressure relief valve 403 opens may be greater than the second pressure level at which the second storage tank 40 stores carbon dioxide. When the third pressure relief valve 403 opens, a pressure difference between the predetermined third pressure and the second pressure level may cause the gaseous carbon dioxide in the distillation tank 30 to move to the second storage tank 40 without a separate power source. When the third pressure relief valve 403 is opened, the carbon dioxide discharged from the distillation tank 30 to the third discharge flow path 413 may move along the connecting flow path 414 to the second storage tank 40.

As described above, the washing machine according to an embodiment may include the first pressure relief valve 402 connected to the washing tub 20, the second pressure relief valve 401 connected to the first storage tank 10, and the third pressure relief valve 403 connected to the distillation tank 30. As a result, the pressure in the washing tub 20, the first storage tank 10, and the distillation tank 30 may be prevented from being excessively high in advance. In addition, when the pressure in the washing tub 20, the first storage tank 10, and the distillation tank 30 becomes excessively high, the carbon dioxide in the washing tub 20, the first storage tank 10, and the distillation tank 30 may be stored in the second storage tank 40 without releasing it to the outside, thereby reusing the carbon dioxide.

Referring to FIG. 1, the washing machine may further include a discharge flow path 415 connecting the second storage tank 40 and an inlet side of the compressor 50 in order to allow the carbon dioxide discharged from the second storage tank 40 to move to the inlet side of the compressor 50.

In addition, the washing machine may further include a fourth pressure relief valve 404. The fourth pressure relief valve 404 may be provided on the fourth discharge flow path 415 to selectively communicate with the second storage tank 40 and the compressor 50. In other words, the fourth pressure relief valve 404 may be opened or closed by external control to selectively communicate with the second storage tank 40 and the compressor 50.

Although not shown in the drawings, according to an embodiment, the fourth pressure relief valve 404 may be opened or closed by the controller 80.

When the fourth pressure relief valve 404 opens, the gaseous carbon dioxide in the second storage tank 40 may move to the inlet side of the compressor 50. That is, the fourth pressure relief valve 404 may be opened when recycling of the gaseous carbon dioxide stored in the second storage tank 40 is required. When the fourth pressure relief valve 404 opens, the gaseous carbon dioxide stored in the second storage tank 40 may be moved to the inlet side of the compressor 50 and be guided to the first storage tank 10 by the compressor 50, thereby enabling recycling.

On the other hand, the fourth pressure relief valve 404 may be provided to open in response to the pressure in the second storage tank 40 being greater than or equal to a predetermined fourth pressure, and may be configured as the same or similar to the first to third pressure relief valves 401, 402, and 403. In this case, the fourth pressure relief valve 404 may include a fourth elastic member. An elastic force of the fourth elastic member may be smaller than the elastic force of the first elastic member. The elastic force of the fourth elastic member may be smaller than the elastic force of the second elastic member. The elastic force of the fourth elastic member may be smaller than the elastic force of the third elastic member. In other words, the predetermined fourth pressure may be smaller than the predetermined first to third pressures.

The predetermined fourth pressure at which the fourth pressure relief valve 404 opens may be greater than the second pressure level at which the second storage tank 40 stores carbon dioxide. This is because the fourth pressure relief valve 404 is required to open to prevent accidents, such as an explosion of the second storage tank 40, due to excessive pressure in the second storage tank 40.

The predetermined fourth pressure may be higher than the pressure at the inlet side of the compressor 50. When the fourth pressure relief valve 404 opens, a pressure difference between the predetermined fourth pressure and the inlet side of the compressor 50 may cause the gaseous carbon dioxide in the second storage tank 40 to move to the compressor 50 without a separate power source. When the fourth pressure relief valve 404 opens, the carbon dioxide discharged from the second storage tank 40 to the fourth discharge flow path 415 may move along the fourth discharge flow path 415 to the inlet side of the compressor 50. Hereinafter, the inlet side of the compressor 50 may be referred to as an inlet end of the compressor 50.

The carbon dioxide entering the compressor 50 through the inlet end of the compressor 50 may pass through the compressor 50 and then move through the distillation tank 30 to the first storage tank 10. In contrast, the carbon dioxide entering the compressor 50 through the inlet end of the compressor 50 may pass through the compressor 50 and then move through the washing tub 20 to the first storage tank 10 or the second storage tank 40.

As described above, the washing machine according to an embodiment may prevent the internal pressure of the second storage tank 40 from becoming excessively high in advance by including the fourth discharge flow path 415 connected to the second storage tank 40 and the fourth discharge flow path 415 provided on the fourth discharge flow path 415 and configured to open in response to the pressure in the second storage tank 40 being greater than or equal to the predetermined fourth pressure. In addition, when the pressure in the second storage tank 40 becomes too high, the carbon dioxide in the second storage tank 40 may be moved to the inlet side of the compressor 50 instead of being discharged to the outside, thereby reusing the carbon dioxide.

Referring to FIG. 1, the washing machine may include a valve provided on a flow path through which carbon dioxide moves. The flow path may include a gas flow path through which gaseous carbon dioxide primarily moves, and a liquid flow path through which liquid carbon dioxide primarily moves. The valve may include a gas valve provided to open or close the gas flow path through which gaseous carbon dioxide mainly moves. The valve may include a liquid valve provided to open or close the liquid flow path through which liquid carbon dioxide mainly moves. The washing machine may include a flow path connecting portion in which a plurality of flow paths are merged into a single flow path or a single flow path is branched into a plurality of flow paths.

More particularly, the valve may include first to eighteenth valves 101-118. The flow path may include first to twelfth flow paths 201-212. The flow path connecting portion may include a first flow path connecting portion to a sixth flow path connecting portion 301-306.

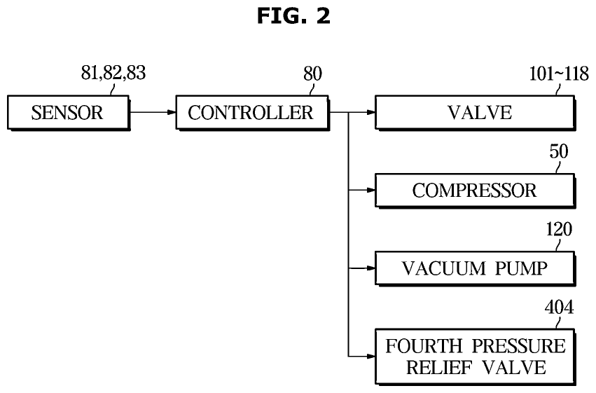

FIG. 2 is a control block diagram of the washing machine according to an embodiment.

Referring to FIG. 2, the washing machine may include a first pressure sensor 81 provided to detect the pressure in the first storage tank 10, a second pressure sensor 82 provided to detect the pressure in the washing tub 20, and a third pressure sensor 83 provided to detect the pressure in the second storage tank 40.

The washing machine may include a controller 80 provided to control the first to eighteenth valves 101-118, the compressor 50, and the vacuum pump 120.

The controller 80 may receive pressure data measured by the first pressure sensor 81, the second pressure sensor 82, and the third pressure sensor 83, respectively. The controller 80 may control the first to eighteenth valves 101-118, the compressor 50, and the vacuum pump 120 based on the pressure data received from the first pressure sensor 81, the second pressure sensor 82, and the third pressure sensor 83.

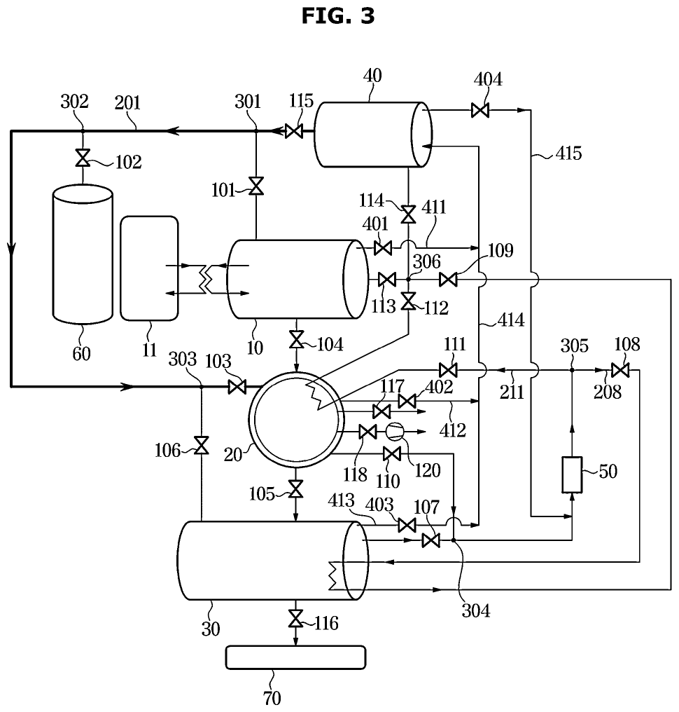

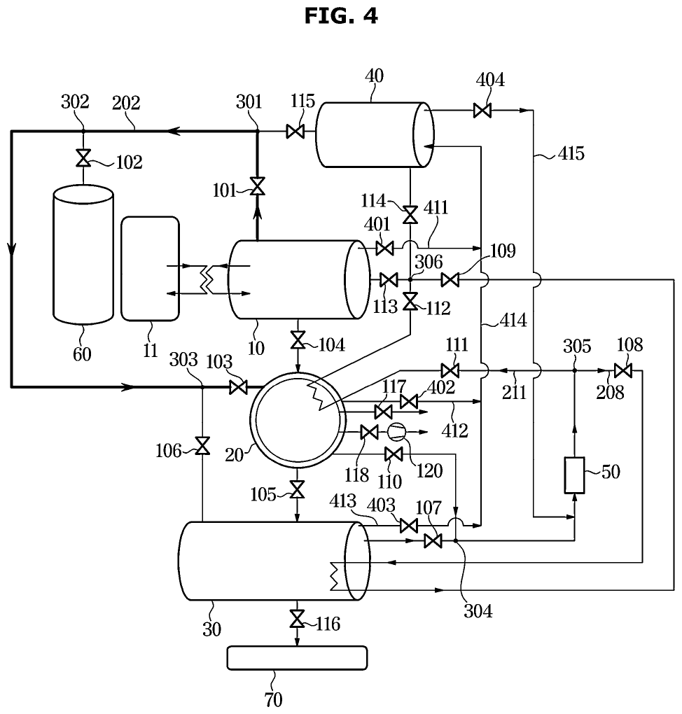

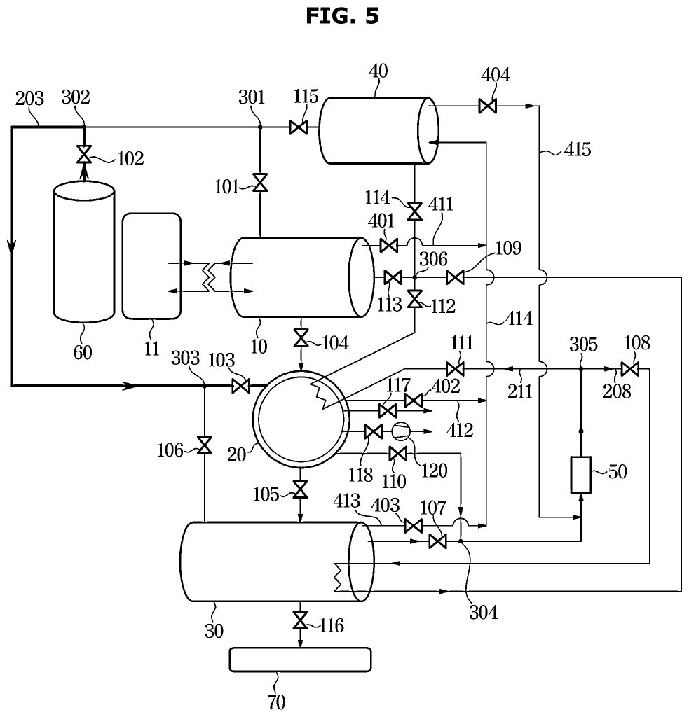

FIG. 3 is a conceptual diagram illustrating the flow path of gaseous carbon dioxide moving from the second storage tank to the washing tub in the washing machine according to an embodiment. FIG. 4 is a conceptual diagram illustrating the flow path of carbon dioxide moving from the first storage tank to the washing machine in the washing machine according to an embodiment. FIG. 5 is a conceptual diagram illustrating a flow path of carbon dioxide moving from the supplementary tank to the washing tub in the washing machine according to an embodiment.

With reference to FIGS. 3 to 5, the process of filling the washing tub 20 of the washing machine with gaseous carbon dioxide will be described.

As described above, the washing tub 20 may receive the drum (not shown) in which laundry is loaded therein and rotatably arranged thereto. The washing tub 20 may include a laundry inlet for placing laundry into the washing tub 20, and a door for opening or closing the laundry inlet. After the door is opened, the user may place laundry into the drum via the laundry inlet. When the user is finished loading the laundry, the user may close the door of the washing tub 20.

In response to the laundry being placed into the washing tub 20 and the door being closed, the controller 80 may operate the vacuum pump 120 to evacuate the air introduced into the washing tub 20 along with the laundry to the outside of the washing tub 20.

Referring to FIG. 3, the washing machine according to an embodiment may supply carbon dioxide from the second storage tank 40 to the washing tub 20 after the operation of the vacuum pump 120. Hereinafter, a process of increasing the pressure in the washing tub 20 by filling the washing tub 20, which has a very low internal pressure due to the operation of the vacuum pump 120, with carbon dioxide may be referred to as a pressurization process. The pressurization process may include a first pressurization process of supplying carbon dioxide from the second storage tank 40 to the washing tub 20.

The washing machine may include the first flow path 201 connecting the second storage tank 40 and the washing tub 20. The carbon dioxide in the second storage tank 40 may be moved to the washing tub 20 along the first flow path 201. The first flow path 201 may be provided with the fifteenth valve 115 and the third valve 103. The first flow path 201 may be provided with the first flow path connecting portion 301, the second flow path connecting portion 302, and the third flow path connecting portion 303. The second flow path connecting portion 302 may be located on a downstream side of the first flow path connecting portion 301 in the first flow path 201 connecting the second storage tank 40 and the washing tub 20. The third flow path connecting portion 303 may be located on a downstream side of the second flow path connecting portion 302 in the first flow path 201.

The fifteenth valve 115 may be disposed between the second storage tank 40 and the first flow path connecting portion 301 to open or close the first flow path 201. The third valve 103 may be disposed between the third flow path connecting portion 303 and the washing tub 20 to open or close the first flow path 201.

In the first pressurization process, the controller 80 may open the fifteenth valve 115 and the third valve 103 to supply the carbon dioxide stored in the second storage tank 40 to the washing tub 20. When the fifteenth valve 115 and the third valve 103 are opened, the pressure in the second storage tank 40 may be approximately 10 to 70 bar and the pressure in the washing tub 20 may be a low pressure close to vacuum. As a result, the pressure difference between the storage tank 40 and the washing tub 20 may cause the carbon dioxide in the second storage tank 40 to be moved into the washing tub 20 without a separate power source.

In the first pressurization process, the controller 80 may close the first valve 101 to prevent the carbon dioxide in the first storage tank 10 from entering the second storage tank 40 or being moved to the washing tub 20, and to prevent the carbon dioxide in the second storage tank 10 from entering the washing tub 20. The first valve 101 may be disposed on a flow path connecting the first flow connecting portion 301 and the first storage tank 10.

In the first pressurization process, the controller 80 may close the second valve 102 to prevent the gaseous carbon dioxide in the supplementary tank 60, which has a higher internal pressure than the second storage tank 40, from entering the second storage tank 40 or being moved to the washing tub 20. The second valve 102 may be disposed on a flow path connecting the second flow path connecting portion 302 and the supplementary tank 60.

In the first pressurization process, the controller 80 may close the sixth valve 106 to prevent the carbon dioxide in the second storage tank 40 from being moved into the distillation tank 30. The sixth valve 106 may be disposed on a flow path connecting the third flow path connecting portion 303 and the distillation tank 30.

The controller 80 may close the fifteenth valve 115 and the third valve 103 when the pressure in the washing tub 20 is balanced with the pressure in the second storage tank 40. In contrast, the controller 80 may close the fifteenth valve 115 and the third valve 103 before the pressure in the washing tub 20 is balanced with the pressure in the second storage tank 40.

Referring to FIG. 4, the washing machine may supply carbon dioxide from the first storage tank 10 to the washing tub 20 after the first pressurization process. The pressurization process may include a second pressurization process of supplying carbon dioxide from the first storage tank 10 to the washing tub 20.

The washing machine may include the second flow path 202 connecting the first storage tank 10 and the washing tub 20. The carbon dioxide in the first storage tank 10 may be moved to the washing tub 20 along the second flow path 202. The first valve 101 and the third valve 103 may be arranged on the second flow path 202. The second flow path 202 may be provided with the first flow path connecting portion 301, the second flow path connecting portion 302, and the third flow path connecting portion 303. A portion of the first flow path 201 connecting the washing tub 20 from the first flow path connecting portion 301 and a portion of the second flow path 202 connecting the washing tub 20 from the first flow path connecting portion 301 may be the same flow path.

In the second pressurization process, the controller 80 may open the first valve 101 and the third valve 103 to supply the gaseous carbon dioxide stored in the first storage tank 10 to the washing tub 20. The pressure in the first storage tank 10 may be approximately 30 to 70 bar and the pressure in the washing tub 20 after the first pressurization process may be less than or equal to the internal pressure of the second storage tank 40, so that the gaseous carbon dioxide in the first storage tank 10 may be moved into the washing tub 20 without a separate power source due to the pressure difference between the storage tank 10 and the washing tub 20.

In the second pressurization process, the controller 80 may close the fifteenth valve 115 to prevent the gaseous carbon dioxide in the first storage tank 10 from entering the second storage tank 40. The fifteenth valve 115 may be disposed on a flow path connecting the first flow path connecting portion 301 and the second storage tank 40. The controller 80 may close the second valve 102 to prevent the gaseous carbon dioxide in the supplementary tank 60 from entering the first storage tank 10 or to prevent the gaseous carbon dioxide in the first storage tank 10 from entering the supplementary tank 60. In addition, the controller 80 may close the sixth valve 106 to prevent the gaseous carbon dioxide in the first storage tank 10 from being moved into the distillation tank 30.

The controller 80 may interrupt the pressurization process in response to the pressure in the washing tub 20 rising to a set value of approximately 30 to 60 bar after the first and second pressurization processes described above. In the event that the pressure in the washing tub 20 does not rise to approximately 30 to 60 bar after the first and second pressurization processes due to carbon dioxide lost in a carbon dioxide recovery process, a third pressurization process, which will be described later, may be further included.

Referring to FIG. 5, the pressurization process may further include the third pressurization process of supplying carbon dioxide from the supplementary tank 60 to the washing tub 20.

The washing machine may include the third flow path 203 connecting the supplementary tank 60 and the washing tub 20. The carbon dioxide in the supplementary tank 60 may be moved to the washing tub 20 along the third flow path 203. The second valve 102 and the third valve 103 may be provided on the third flow path 203. The third flow path 203 may be provided with the second flow path connecting portion 302 and the third flow path connecting portion 303. A portion of the first flow path 201 connecting the washing tub 20 from the second flow path connecting portion 302, a portion of the second flow path 202 connecting the washing tub 20 from the second flow path connecting portion 302, and a portion of the third flow path 203 connecting the washing tub 20 from the second flow path connecting portion 302 may be the same flow path.

In the third pressurization process, the controller 80 may open the second valve 102 and the third valve 103 to supply the gaseous carbon dioxide stored in the supplementary tank 60 to the washing tub 20. The pressure in the supplementary tank 60 may be higher than the set pressure in the washing tub 20, so that the gaseous carbon dioxide in the supplementary tank 60 may be moved into the washing tub 20 without a separate power source due to the pressure difference between the supplementary tank 60 and the washing tub 20.

In the third pressurization process, the controller 80 may close the fifteenth valve 115 to prevent the gaseous carbon dioxide in the supplementary tank 60 from entering the second storage tank 40. The controller 80 may close the first valve 101 to prevent the gaseous carbon dioxide in the supplementary tank 60 from entering the first storage tank 10 or to prevent the gaseous carbon dioxide in the first storage tank 10 from entering the supplementary tank 60. The controller 80 may close the sixth valve 106 to prevent the gaseous carbon dioxide in the supplementary tank 60 from being moved into the distillation tank 30.

The controller 80 may close the second valve 102 and the third valve 103 when the pressure in the washing tub 20 rises to a set value of approximately 30 to 60 bar. Once the controller 80 closes the second valve 102 and the third valve 103, the third pressurization process may be stopped.

In the washing machine according to an embodiment, the pressurization process may include the first pressurization process, the second pressurization process, and the third pressurization process described above. Alternatively, the pressurization process may include only the first pressurization process and the third pressurization process, or may include only the first pressurization process and the second pressurization process. In in some cases, the first pressurization process, the second pressurization process, and the third pressurization process may be performed in a different order.

Although not shown in the drawings, the carbon dioxide in the supplementary tank 60 may be supplied to the first storage tank 10 or the second storage tank 40. To allow the carbon dioxide in the supplementary tank 60 to be moved to the first storage tank 10, the second valve 102 and the first valve 101 may be opened and the third valve 103, the sixth valve 106, and the fifteenth valve 115 may be closed. To allow the carbon dioxide in the supplementary tank 60 to be moved to the second storage tank 40, the second valve 102 and the fifteenth valve 115 may be opened, and the third valve 103, the sixth valve 106, and the first valve 101 may be closed.

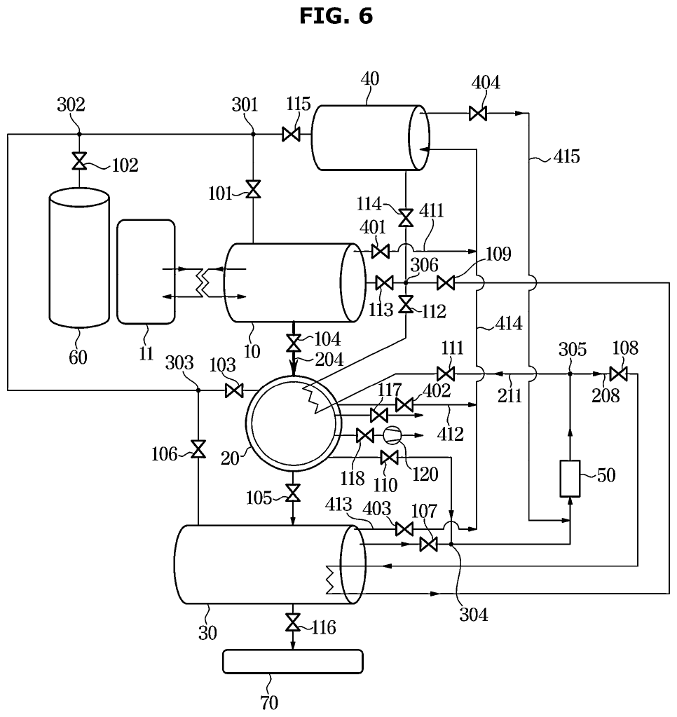

FIG. 6 is a conceptual diagram illustrating a flow path of liquid carbon dioxide moving from the first storage tank to the washing tub in the washing machine according to an embodiment.

Referring to FIG. 6, the washing machine may supply carbon dioxide to the washing tub 20 after the pressurization process. The washing machine may include the fourth flow path 204 connecting the first storage tank 10 and the washing tub 20. The fourth flow path 204 may be a liquid flow path through which liquid carbon dioxide predominantly moves, and may refer to a flow path different from the second flow path 202, which is a gas flow path through which gaseous carbon dioxide predominantly moves. Liquid carbon dioxide and gaseous carbon dioxide coexist within the washing tub 20, and depending on temperature and pressure conditions, liquid carbon dioxide may be evaporated or gaseous carbon dioxide may be liquefied. Accordingly, liquid carbon dioxide and gaseous carbon dioxide may move together along the fourth flow path 204, and gaseous carbon dioxide and liquid carbon dioxide may move together along the second flow path 202. The fourth valve 104 may be provided on the fourth flow path 204. The fourth valve 104 may be configured to open or close the fourth flow path 204.

The washing machine may supply the liquid carbon dioxide stored in the first storage tank 10 to the washing tub 20. As described above, the first storage tank 10 may be positioned higher than the washing tub 20, so that the liquid carbon dioxide in the first storage tank 10 may be moved to the washing tub 20 by gravity without a separate power source. The controller 80 may open the fourth valve 104 to supply liquid carbon dioxide from the first storage tank 10 to the washing tub 20. In response to the controller 80 opening the fourth valve 104, the liquid carbon dioxide in the first storage tank 10 may be moved to the washing tub 20 by gravity.

After liquid carbon dioxide is supplied to the washing tub 20, washing may be performed by rotating the drum. Since liquid carbon dioxide has a lower viscosity than water, it may easily penetrate between fibers to remove contaminants. During the process, liquid carbon dioxide may dissolve foreign matter (or substances) in the laundry. Some foreign matter in laundry may not be dissolved in liquid carbon dioxide because it has a different polarity from carbon dioxide.

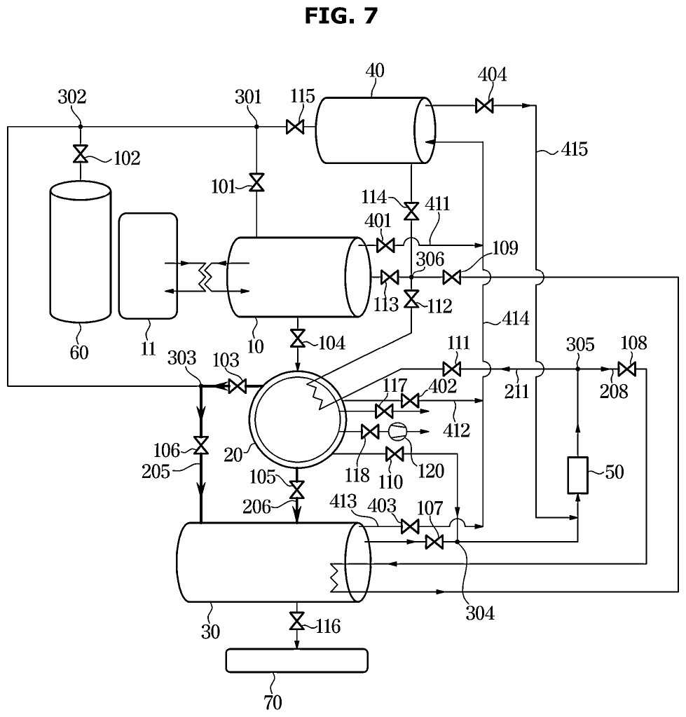

FIG. 7 is a conceptual diagram illustrating a flow path of gaseous carbon dioxide moving from the washing tub to the distillation tank and a flow path of liquid carbon dioxide moving from the washing tub to the distillation tank in the washing machine according to an embodiment.

Referring to FIG. 7, when the washing is complete, the washing machine may discharge liquid carbon dioxide and foreign matter inside the washing tub 20 into the distillation tank 30. At this time, the controller 80 may open the third valve 103 and the sixth valve 106 to eliminate the difference between the pressure in the washing tub 20 and the pressure in the distillation tank 30. The third valve 103 and the sixth valve 106 may be provided on the fifth flow path 205 connecting the washing tub 20 and the distillation tank 30. The fifth flow path 205 may be a gas flow path, and the third flow path connecting portion 303 may be provided in the fifth flow path 205. The third valve 103 may be provided on an upstream side of the third flow path connecting portion 303 in the fifth flow path 205. The sixth valve 106 may be provided on a downstream side of the third flow path connecting portion 303 in the fifth flow path 205.

The controller 80 may open the fifth valve 105 to allow liquid carbon dioxide and foreign matter inside the washing tub 20 to be discharged into the distillation tank 30. The fifth valve 105 may be provided in the sixth flow path 206 connecting the washing tub 20 and the distillation tank 30. The sixth flow path 206 may be a liquid flow path through which liquid carbon dioxide and foreign matter move. The fifth valve 105 may be configured to open or close the sixth flow path 206.

The distillation tank 30 may be disposed on a lower side of the washing tub 20. This is to allow liquid carbon dioxide and foreign matter inside the washing tub 20 to be moved to the distillation tank 30 by gravity without a separate power source when the fifth valve 105 is opened.

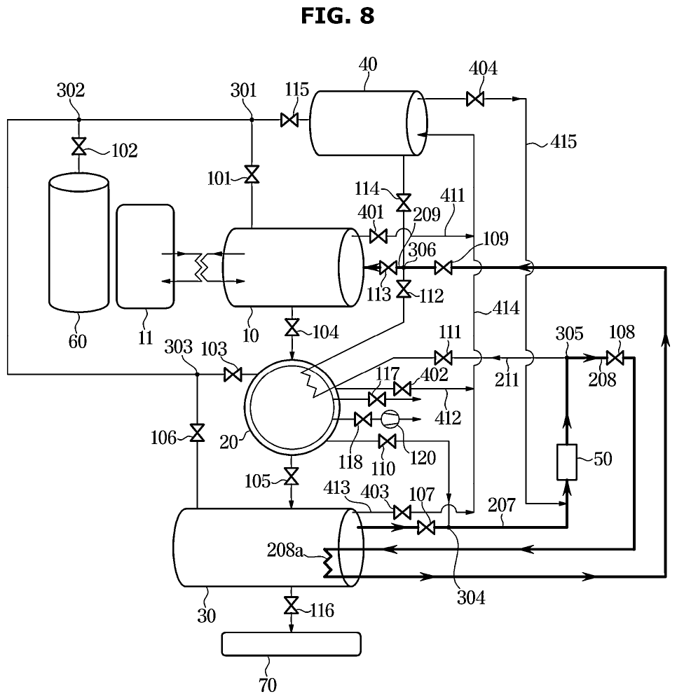

FIG. 8 is a conceptual diagram illustrating a process of returning carbon dioxide in the distillation tank to the first storage tank, in the washing machine according to an embodiment.

Referring to FIG. 8, the washing machine may return carbon dioxide discharged from the washing tub 20 into the distillation tank 30 to the first storage tank 10.

The washing machine may return the gaseous carbon dioxide in the distillation tank 30 to the first storage tank 10, or vaporize the liquid carbon dioxide in the distillation tank 30 and then return the vaporized carbon dioxide to the first storage tank 10.

The washing machine may include the seventh flow path 207 connecting the distillation tank 30 and an input end of the compressor 50. The seventh valve 107 may be provided on the seventh flow path 207. The fourth flow path connecting portion 304 may be provided in the seventh flow path 207. The fourth flow path connecting portion 304 may be located on a downstream side of the seventh valve 107. The fourth flow path connecting portion 304 may be connected to the washing tub 20. The fourth flow path connecting portion 304 may connect the tenth flow path 210 and the seventh flow path 207.

The controller 80 may move the gaseous carbon dioxide in the distillation tank 30 to the input end of the compressor 50 by opening the seventh valve 107. In response to the opening of the seventh valve 107, the gaseous carbon dioxide in the distillation tank 30 may be moved along the seventh flow path 207 and enter the input end of the compressor 50.

The washing machine may include the eighth flow path 208 connecting an output end of the compressor 50 and the sixth flow path connection portion 306. The eighth flow path 208 may be provided with the fifth flow path connecting portion 305, the eighth valve 108, and the ninth valve 109. The eighth flow path 208 may include a distillation tank heat exchange portion 208a. The eighth valve 108 may be disposed on a downstream side of the fifth flow path connecting portion 305. The ninth valve 109 may be disposed on a downstream side of the eighth valve 108. The distillation tank heat exchange portion 208a may be disposed between the eighth valve 108 and the ninth valve 109 and may be arranged via the distillation tank 30. The sixth flow path connecting portion 306 may refer to a point where the eighth flow path 208, the ninth flow path 209, the eleventh flow path 211, and the twelfth flow path 212 are connected to each other.

The controller 80 may open the eighth valve 108 and the ninth valve 109. In response to the opening of the eighth valve 108 and the ninth valve 109, gaseous carbon dioxide at a high temperature and a high pressure that has passed through the compressor 50 may be moved through the distillation tank heat exchange portion 208a. The distillation tank heat exchange portion 208a may be a portion of the eighth flow path 208, which may be through the interior of the distillation tank 208 or through the exterior of the distillation tank 208 adjacent to the distillation tank 208. As described above, high temperature carbon dioxide that has passed through the compressor 50 may be moved into the interior of the distillation tank heat exchange portion 208a. As a result, the distillation tank heat exchange portion 208a may maintain the high temperature. The distillation tank heat exchange portion 208a may supply heat to the interior or exterior of the distillation tank 30. The liquid carbon dioxide in the distillation tank 30 may be evaporated by the heat supplied to the distillation tank 30 from the distillation tank heat exchange portion 208a. Liquid carbon dioxide and foreign matter dissolved in liquid carbon dioxide may be accommodated in the distillation tank 30. As the liquid carbon dioxide evaporates inside the distillation tank 30, the foreign matter dissolved in the liquid carbon dioxide may be separated from the carbon dioxide. The foreign matter separated from the carbon dioxide may be discharged from the distillation tank 30 into the foreign matter tank 70 by opening the sixteenth valve 116. To this end, the controller 80 may open the sixteenth valve 116.

The controller 80 may open the thirteenth valve 113. In response to the opening of the eighth valve 108 and the ninth valve 109, the carbon dioxide that has passed through the distillation tank heat exchange portion 208a from the output end of the compressor 50 may be moved to the sixth flow path connecting portion 306. In response to the opening of the thirteenth valve 113, the carbon dioxide that has moved to the sixth flow path connecting portion 306 may be introduced into the first storage tank 10. At this time, the controller 80 may close the twelfth valve 112 and the fourteenth valve 114 to prevent the carbon dioxide moving to the sixth flow path connecting portion 306 from moving to the eleventh flow path 211 and the twelfth flow path 212, which will be described later.

In addition, gaseous carbon dioxide may be heat exchanged with the chiller 11 or an external heat exchanger before entering the first storage tank 10 from the sixth flow path connecting 306, thereby liquefying gaseous carbon dioxide into liquid carbon dioxide and entering the first storage tank 10.

As described above, to return the carbon dioxide in the distillation tank 30 to the first storage tank 10, the controller 80 may open the seventh valve 107, the eighth valve 108, the ninth valve 109, and the thirteenth valve 113. In addition, the controller 80 may control the compressor 50 to cause the compressor 50 to operate.

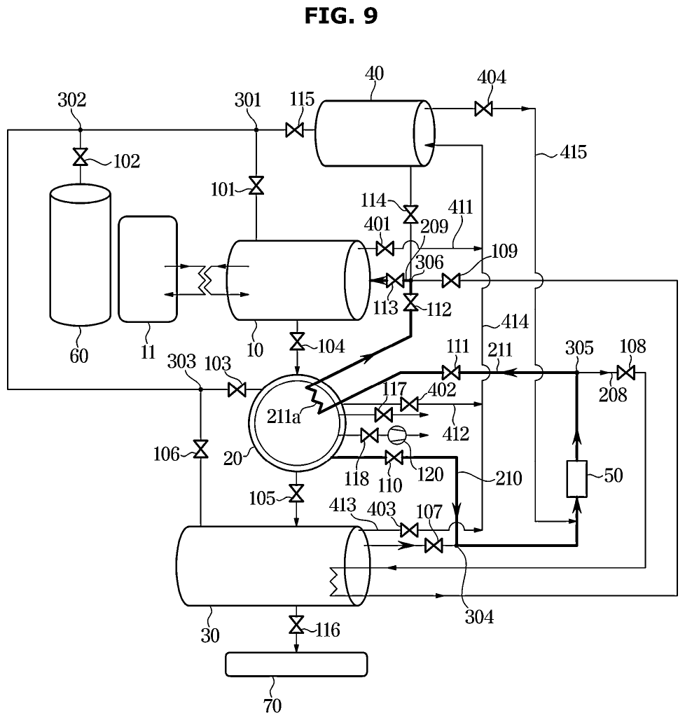

FIG. 9 is a conceptual diagram illustrating a process of returning carbon dioxide in the washing tub to the first storage tank, in the washing machine according to an embodiment.

Referring to FIG. 9, a depressurization process for depressurizing the interior of the washing tub 20 to remove the laundry from the washing tub 20 after the washing is complete will be described.

The depressurization process may refer to a process of reducing the pressure in the washing tub 20 to a level similar to atmospheric pressure, such as 1 to 1.5 bar. The depressurization process may include a first depressurization process of reducing the pressure in the washing tub 20 by returning the carbon dioxide in the washing tub 20 to the first storage tank 10.

Referring to FIG. 9, the washing machine may include the tenth flow path 210 connecting the washing tub 20 and the input end of the compressor 50. The tenth valve 110 may be provided on the tenth flow path 210. The fourth flow path connecting portion 304 may be provided in the tenth flow path 210. The fourth flow path connecting portion 304 may be disposed on a downstream side of the tenth valve 110. The fourth flow path connecting portion 304 may be connected to the distillation tank 30. The tenth flow path 210 and the seventh flow path 207 may be connected at the fourth flow path connecting portion 304.

The washing machine may include the eleventh flow path 211 connecting the output end of the compressor 50 and the sixth flow path connection portion 306. The eleventh flow path 211 may include a washing tub heat exchange portion 211a. The eleventh valve 111 and the twelfth valve 112 may be provided on the eleventh flow path 211. The eleventh valve 111 may be located on an upstream side of the twelfth valve 112, and the washing tub heat exchange portion 211a may be disposed between the eleventh valve 111 and the twelfth valve 112. The washing tub heat exchange portion 211a may be a portion of the eleventh flow path 211, which may be through the interior of the washing tub 20 or through the exterior of the washing tub 20 adjacent to the washing tub 20.

Referring to FIG. 9, in the first depressurization process, the controller 80 may open the tenth valve 110. In response to the opening of the tenth valve 110, the carbon dioxide in the washing tub 20 may move along the tenth flow path 210 and enter the input end of the compressor 50.

In the first depressurization process, the controller 80 may open the eleventh valve 111. In response to the opening of the eleventh valve 111, the high temperature and high pressure carbon dioxide discharged from the output end of the compressor 50 may move along the eleventh flow path 211, pass through the washing tub heat exchange portion 211a, and reach the sixth flow path connecting portion 306.

Since the high temperature carbon dioxide that has passed through the compressor 50 moves inside the washing tub heat exchange portion 211a, the washing tub heat exchange portion 211a may maintain the high temperature. The washing tub heat exchange portion 211a may supply heat to the interior or exterior of the washing tub 20. The heat supplied to the washing tub 20 from the washing tub heat exchange portion 211a may prevent the laundry in the washing tub 20 from being damaged by moisture condensation.

As described above, after the laundry is loaded into the washing tub 20, the door of the washing tub is closed and the vacuum pump 120 is operated to create a low pressure state close to a vacuum inside the washing tub 20. However, the interior of the washing tub 20 may not be completely vacuumed, and some air may remain inside the washing tub 20. The remaining air in the washing tub 20 may contain moisture, and the moisture may condense during the process of reducing the pressure in the washing tub 20. This is because when the pressure in the washing tub 20 decreases, the temperature inside the washing tub 20 decreases.

Once moisture that has penetrated the laundry condenses, the laundry may be damaged. To prevent such a situation, the temperature inside the washing tub 20 may need to be maintained above freezing during the depressurization process. For example, the temperature inside the washing tub 20 may be maintained at approximately 10 degrees or higher. A separate heater may be included to increase the temperature inside the washing tub 20, but this is not efficient in terms of energy. Accordingly, the washing machine according to the present disclosure may use the heat of the high temperature carbon dioxide passing through the compressor 50 to provide heat to the interior of the washing tub 20. Specifically, the flow path through which the high temperature carbon dioxide passing through the compressor 50 may be through the interior or exterior of the washing tub 20, thereby providing heat to the washing tub 20.

In the first depressurization process, the controller 80 may open the thirteenth valve 113. In response to the opening of the thirteenth valve 113, the carbon dioxide moving to the sixth flow path connecting portion 306 may be moved to the first storage tank 10 along the ninth flow path 209. The ninth flow path 209 may connect the sixth flow path connecting portion 306 and the first storage tank 10. The thirteenth valve 113 may be provided on the ninth flow path 209.

By opening the tenth valve 110, the eleventh valve 111, the twelfth valve 112, and the thirteenth valve 113, the carbon dioxide discharged from the washing tub 20 may be moved to the first storage tank 10 through the compressor 50. To enable the carbon dioxide discharged from the washing tub 20 to be moved to the first storage tank 10 through the compressor 50, the flow paths 210, 211, and 209 connecting the washing tub 20, the compressor 50, and the first storage tank 10 may be referred to as a first washing tub recovery flow path.

In the first depressurization process, which corresponds to an initial stage of depressurizing the interior of the washing tub 20, the carbon dioxide in the washing tub 20 may be recovered into the first storage tank 10.

Since the internal pressure of the washing tub 20 is in a high state immediately after the washing is completed, it may be easy to recover the carbon dioxide into the first storage tank 10 where the pressure difference between the internal pressure of the washing tub 20 and the pressure of the first storage tank 10 is relatively small. This is because the pressure difference between the input end and the output end of the compressor 50 may be relatively small. Since the input end of the compressor 50 is connected to the washing tub 20 and the output end of the compressor 50 is connected to the first storage tank 10, when the pressure difference between the washing tub 20 and the first storage tank 10 is small, the pressure difference between the input end and the output end of the compressor 50 may also be small, and thus the load on the compressor 50 may be small.

As the first depressurization process proceeds, the carbon dioxide in the washing tub 20 may be recovered into the first storage tank 10, and the pressure in the washing tub 20 may be gradually lowered. Since the pressure in the washing tub 20 is lowered and the pressure in the first storage tank 10 is maintained at a certain level, the load on the compressor 50 may gradually increase. If the compressor 50 is overloaded, the compressor 50 may be damaged.

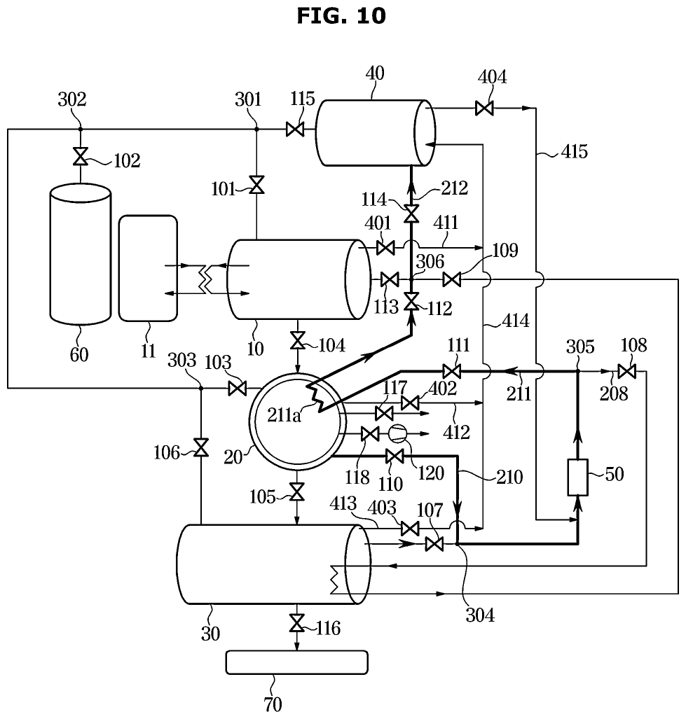

FIG. 10 is a conceptual diagram illustrating a process of recovering the carbon dioxide in the washing tub to the second storage tank in the washing machine according to an embodiment.

With reference to FIG. 10, a second first depressurization process according to an embodiment will be described.

The depressurization process may include the second depressurization process to reduce the pressure in the washing tub 20 is lowered by recovering the carbon dioxide in the washing tub 20 to the second storage tank 40 rather than the first storage tank 10 after the first depressurization process.

In the second depressurization process, the controller 80 may open the fourteenth valve 114 and close the thirteenth valve 113. In response to the opening of the fourteenth valve 114, the carbon dioxide moving to the sixth flow path connecting portion 306 may be moved to the second storage tank 40. In response to the closing of the thirteenth valve 113, the carbon dioxide moving to the sixth flow path connecting portion 306 may not be moved to the first storage tank 10.

By opening the fourteenth valve 114 and closing the thirteenth valve 113, the carbon dioxide discharged from the washing tub 20 may be moved to the second storage tank 40 through the compressor 50. To enable the carbon dioxide discharged from the washing tub 20 to be moved to the second storage tank 40 through the compressor 50, the flow paths 210, 211, and 212 connecting the washing tub 20, the compressor 50, and the second storage tank 40 may be referred to as a second washing tub recovery flow path.

As described above, as the first depressurization process proceeds, the pressure in the washing tub 20 may gradually decrease, causing the pressure difference with the pressure in the first storage tank 10 to gradually increase. As a result, the pressure difference between the input end and the output end of the compressor 50 increases, so that the load on the compressor 50 may gradually increase.

According to the present disclosure, the load on the compressor 50 may be reduced by including the second depressurization process after the first depressurization process. By reducing the load on the compressor 50, damage to the compressor 50 may be prevented.

The internal pressure of the second storage tank 40 may be maintained at a lower level than the internal pressure of the first storage tank 10. When the internal pressure of the washing tub 20 is in a lowered state, the pressure difference between the washing tub 20 and the second storage tank 40 is smaller than the pressure difference between the washing tub 20 and the first storage tank 10. When the fourteenth valve 114 is opened, the input end of the compressor 50 may be connected to the washing tub 20 and the output end of the compressor 50 may be connected to the second storage tank 40. Accordingly, the pressure difference between the input end and the output end of the compressor 50 may be less than that in the first depressurization process. This may mean that the load on the compressor 50 is reduced and the compressor 50 may not be operated excessively, thereby preventing the life of the compressor 50 from being reduced.

According to the present disclosure, the depressurization process of depressurizing the interior of the washing tub 20 after the washing is completed may include the first depressurization process and the second depressurization process. As a result, the load on the compressor 50 may be reduced, damage to the compressor 50 may be prevented, and the service life of the compressor 50 may be increased. Furthermore, the interior of the washing tub 20 may be depressurized using only one compressor 50 without overloading the compressor 50. By including only one compressor 50, the configurations of the washing machine may be relatively simple, and the noise and vibration caused by the compressor 50 may be reduced compared to a washing machine including a plurality of compressors 50.

According to an embodiment, the washing machine may include the washing tub configured to wash laundry using carbon dioxide, the compressor configured to compress the carbon dioxide discharged from the washing tub, the first storage tank connected to the compressor and configured to store carbon dioxide, the second storage tank connected to the compressor and configured to store carbon dioxide, the distillation tank configured to accommodate the carbon dioxide and foreign matter discharged from the washing tub and to evaporate the carbon dioxide therein, the first discharge flow path connecting the washing tub and the second storage tank to allow the carbon dioxide discharged from the washing tub to be moved to the second storage tank, and the first pressure relief valve disposed on the first discharge flow path and configured to open in response to the pressure in the washing tub being greater than or equal to a predetermined first pressure.

The washing machine may further include the third discharge flow path connecting the first storage tank and the second storage tank to allow the carbon dioxide discharged from the first storage tank to be moved to the second storage tank, and the second pressure relief valve disposed on the second discharge flow path and configured to open in response to the pressure in the first storage tank being greater than or equal to a predetermined second pressure.

The washing machine may further include the third discharge flow path connecting the distillation tank and the second storage tank to allow the carbon dioxide discharged from the distillation tank to be moved to the second storage tank, and the third pressure relief valve disposed on the third discharge flow path and configured to open in response to the pressure in the distillation tank being greater than or equal to a predetermined third pressure.

The first storage tank may be configured to store carbon dioxide at the first pressure level.

The second storage tank may be configured to store carbon dioxide at the second pressure level lower than the first pressure level.

The predetermined first pressure, the predetermined second pressure, and the predetermined third pressure may be greater than the second pressure level.

The washing machine may further include the connecting flow path configured to be connected to the first discharge flow path, the second discharge flow path, the third discharge flow path, and the second storage tank, in order to guide the carbon dioxide discharged through the first discharge flow path, the second discharge flow path, and the third discharge flow path to the second storage tank.

The washing machine may further include the fourth discharge flow path connecting the second storage tank and an inlet side of the compressor to allow the carbon dioxide discharged from the second storage tank to be moved to the inlet side of the compressor, and the fourth pressure relief valve disposed on the fourth discharge flow path and configured to open or close the fourth discharge flow path.

The washing machine may further include the controller configured to control the fourth pressure relief valve.

The first pressure relief valve may include the first elastic member, and the predetermined first pressure may be determined by the elastic force of the first elastic member.

The second pressure relief valve may include the second elastic member, and the predetermined second pressure may be determined by the elastic force of the second elastic member.

The third pressure relief valve may include the third elastic member, and the predetermined third pressure may be determined by the elastic force of the third elastic member.

The washing machine may further include the first flow path connecting the second storage tank and the washing tub to provide the carbon dioxide in the second storage tank to the washing tub, the second flow path connecting the first storage tank and the washing tub to provide the carbon dioxide in the first storage tank to the washing tub, the first valve configured to open or close the first flow path, and the second valve configured to open or close the second flow path.

The washing machine may further include the controller configured to control the compressor, the first valve, and the second valve.

The controller may open, when carbon dioxide is supplied to the washing tub, the first valve to allow the carbon dioxide in the second storage tank to be moved to the washing tub.

The controller may close the first valve and open the second valve based on the pressure in the washing tub to allow the carbon dioxide in the first storage tank to be moved to the washing tub.

The controller may close the first valve and open the second valve in response to the pressure in the washing tub being balanced with the pressure in the second storage tank after opening the first valve.

The controller may close the first valve and open the second valve in response to the pressure in the washing tub being greater than or equal to the predetermined pressure after opening the first valve.

According to an embodiment, the washing machine may include the washing tub configured to wash laundry using carbon dioxide, the compressor configured to compress the carbon dioxide discharged from the washing tub, the first storage tank connected to the compressor and configured to store carbon dioxide, the second storage tank separable from the first storage tank and configured to store carbon dioxide, the distillation tank configured to accommodate the carbon dioxide and foreign matter discharged from the washing tub and to evaporate the carbon dioxide therein, the washing tub recovery flow paths connecting the washing tub, the compressor, and the second storage tank to allow the carbon dioxide discharged from the washing tub to be moved to the second storage tank through the compressor, the first discharge flow path connecting the washing tub and the second storage tank to allow the carbon dioxide discharged from the washing tub to be moved to the second storage tank, and the first pressure relief valve disposed on the first discharge flow path and configured to open in response to the pressure in the washing tub being greater than or equal to a predetermined first pressure.

connecting the first storage tank and the second storage tank to allow the carbon dioxide discharged from the first storage tank to be moved to the second storage tank, and the second pressure relief valve disposed on the second discharge flow path and configured to open in response to the pressure in the first storage tank being greater than or equal to a predetermined second pressure.

The washing machine may further include the third discharge flow path connecting the distillation tank and the second storage tank to allow the carbon dioxide discharged from the distillation tank to be moved to the second storage tank, and the third pressure relief valve disposed on the third discharge flow path and configured to open in response to the pressure in the distillation tank being greater than or equal to a predetermined third pressure.

The washing machine may further include the fourth discharge flow path connecting the second storage tank and an inlet side of the compressor to allow the carbon dioxide discharged from the second storage tank to be moved to the inlet side of the compressor, and the fourth pressure relief valve disposed on the fourth discharge flow path and configured to open or close the fourth discharge flow path.

The first pressure relief valve may include the first elastic member, and the predetermined first pressure may be determined by the elastic force of the first elastic member.

The second pressure relief valve may include the second elastic member, and the predetermined second pressure may be determined by the elastic force of the second elastic member.

The third pressure relief valve may include the third elastic member, and the predetermined third pressure may be determined by the elastic force of the third elastic member.

The first storage tank may be configured to store carbon dioxide at the first pressure level.

The second storage tank may be configured to store carbon dioxide at the second pressure level lower than the first pressure level.

The predetermined first pressure, the predetermined second pressure, and the predetermined third pressure may be greater than the second pressure level.

The washing machine may further include the controller 80 configured to control the fourth pressure relief valve.

According to the present disclosure, by including two carbon dioxide storage tanks with different internal pressures, it is possible to provide the washing machine capable of depressurizing the interior of the washing tub with only one compressor after the washing process.

According to the present disclosure, it is possible to provide the washing machine capable of preventing overloading of the compressor by dividing and recovering carbon dioxide in the washing tub into the first storage tank and the second storage tank.

According to the present disclosure, it is possible to provide the washing machine capable of stably maintaining the internal pressure of the washing tub, the first storage tank and the distillation tank by including the pressure relief valves (PRVs) connected with each of the washing tub, the first storage tank and the distillation tank.

According to the present disclosure, it is possible to provide the washing machine capable of reusing carbon dioxide by moving the carbon dioxide discharged through the at least one pressure relief valves to the second storage tank when at least one of the pressure relief valves connected with each of the washing tub, the first storage tank and the distillation tank is opened.

According to the present disclosure, it is possible to provide to the washing machine capable of maintaining stably the internal pressure of the second storage tank by moving the carbon dioxide in the second storage tank to the compressor when the internal pressure of the second storage tank increases greater than or equal to the set value, resulting in reuse of carbon dioxide.

While the present disclosure has been particularly described with reference to exemplary embodiments, it should be understood by those of skilled in the art that various changes in form and details may be made without departing from the spirit and scope of the present disclosure.

1. A washing machine, comprising:
a washing tub configured to wash laundry with carbon dioxide;
a compressor configured to compress the carbon dioxide discharged from the washing tub;
a first storage tank connected to the compressor and configured to store carbon dioxide;
a second storage tank connected to the compressor and configured to store carbon dioxide;
a distillation tank configured to accommodate carbon dioxide and foreign matter discharged from the washing tub and to evaporate the carbon dioxide accommodated in the distillation tank so that the foreign matter and the carbon dioxide evaporated in the distillation tank are separated; and
a first pressure relief valve on a first discharge flow path between the washing tub and the second storage tank, and configured to open in response to a pressure in the washing tub being greater than or equal to a first pressure so that carbon dioxide in the washing tub is moved from the washing tub to the second storage tank.

2. The washing machine of claim 1, further comprising:
a second pressure relief valve on a second discharge flow path between the first storage tank and the second storage tank, and configured to open in response to a pressure in the first storage tank being greater than or equal to a second pressure so that at least a portion of the carbon dioxide stored in the first storage tank is moved from the first storage tank to the second storage tank.

3. The washing machine of claim 2, further comprising:
a third pressure relief valve on a third discharge flow path between the distillation tank and the second storage tank, and configured to open in response to a pressure in the distillation tank being greater than or equal to a third pressure so that at least a portion of the carbon dioxide accommodated in the distillation tank is moved from the distillation tank to the second storage tank.

4. The washing machine of claim 3, wherein
the first storage tank is configured to store carbon dioxide at a first pressure level, and
the second storage tank is configured to store carbon dioxide at a second pressure level which is lower than the first pressure level.

5. The washing machine of claim 4, wherein the first pressure, the second pressure, and the third pressure are greater than the second pressure level.

6. The washing machine of claim 3, further comprising, a connecting flow path configured to connect the first discharge flow path, the second discharge flow path, and the third discharge flow path to the second storage tank to guide movement of carbon dioxide from at least one of the washing tub, the first storage tank, and the distillation tank to the second storage tank.

7. The washing machine of claim 3, further comprising:
a fourth pressure relief valve on a fourth discharge flow path between the second storage tank and an inlet side of the compressor, and configured to open and close so that, when the fourth pressure relief valve is opened, the fourth discharge flow path is opened and carbon dioxide stored in the second storage tank is moved from the second storage tank to the inlet side of the compressor.

8. The washing machine of claim 7, further comprising a controller configured to control the fourth pressure relief valve to open and close.

9. The washing machine of claim 3, wherein
the first pressure relief valve includes a first elastic member and the first pressure is determined by an elastic force of the first elastic member,
the second pressure relief valve includes a second elastic member and the second pressure is determined by an elastic force of the second elastic member, and
the third pressure relief valve includes a third elastic member and the third pressure is determined by an elastic force of the third elastic member.

10. The washing machine of claim 1, further comprising:
a first valve configured to open and close a first flow path between the second storage tank and the washing tub so that, when the first valve is opened, carbon dioxide stored in the second storage tank is moved from the second storage tank to the washing tub, and
a second valve configured to open and close a second flow path between the first storage tank and the washing tub so that, when the second valve is opened, carbon dioxide stored in the first storage tank is moved from the first storage tank to the washing tub.

11. The washing machine of claim 10, further comprising a controller configured to control the compressor, the first valve, and the second valve,
wherein the controller is configured to:
when carbon dioxide is supplied to the washing tub,
open the first valve so that the carbon dioxide stored in the second storage tank is moved to the washing tub, and
based on the pressure in the washing tub, close the first valve and open the second valve so that the carbon dioxide stored in the first storage tank is moved to the washing tub.

12. The washing machine of claim 11, wherein the controller is further configured to:
after opening the first valve, close the first valve and open the second valve in response to the pressure in the washing tub being balanced with the pressure in the second storage tank.

13. The washing machine of claim 11, wherein the controller is further configured to:
after opening the first valve, close the first valve and open the second valve in response to the pressure in the washing tub being greater than or equal to a threshold pressure.
